(19) United States
(12) Patent Application Publication
(10) Pub. No.: US 2019/0340107 A1
(43) Pub. Date: Nov. 7, 2019

(54) SIGNAL CONTROL CIRCUIT

(71) Applicants: KABUSHIKI KAISHA TOSHIBA, Minato-ku (JP); TOSHIBA INFRASTRUCTURE SYSTEMS & SOLUTIONS CORPORATION, Kawasaki-shi (JP)

(72) Inventors: Daichi MOTOJIMA, Fuchu (JP); Motohiko Okabe, Fuchu (JP)

(73) Assignees: KABUSHIKI KAISHA TOSHIBA, Minato-ku (JP); TOSHIBA INFRASTRUCTURE SYSTEMS & SOLUTIONS CORPORATION, Kawasaki-shi (JP)

(21) Appl. No.: 16/392,742

(22) Filed: Apr. 24, 2019

(30) Foreign Application Priority Data
May 1, 2018 (JP) 2018-088249

(51) Int. Cl. G06F 11/36; G06F 11/30

(52) U.S. Cl. CPC G06F 11/3648; G06F 11/3027; G06F 11/3041

(57) ABSTRACT

According to one embodiment, a signal control circuit includes a high-speed serial bus I/F circuit, a data conversion circuit, a trace circuit, and a memory arbitration circuit. The high-speed serial bus I/F circuit receives serial data from an external device by high-speed serial bus communication, and converts the serial data to parallel data. The data conversion circuit converts one of the parallel data to common data to be stored in an external memory. The trace circuit converts the other parallel data to trace data to be stored in the external memory. The memory arbitration circuit stores the common data in a common memory area of the external memory, stores the trace data in a trace memory area being different from the common memory area of the external memory, and when null is supplied from outside, does not store the trace data in the trace memory area.

### CROSS-REFERENCE TO RELATED APPLICATIONS

This application is based upon and claims the benefit of priority from Japanese Patent Application No. 2018-088249, filed May 1, 2018, the entire contents of which are incorporated herein by reference.

### FIELD

Embodiments described herein relate generally o a signal control circuit.

### BACKGROUND

A high-speed data transmission technology using a high-speed bus interface is applied to an industrial control network used for monitoring the status of a plant and a manufacturing facility, and automatically controlling the plant and the manufacturing facility. Moreover, in the high-speed data transfer technology, high-speed serial bus communication with large capacity and that can perform high speed transmission is capable of transferring a large amount of data in the industrial control network.

On the other hand, to analyze the contents of a high-speed serial bus signal that is data to be transferred by the high-speed serial bus communication, a high resolution signal analyzer supporting the signal bandwidth needs to be mounted on a transmission device in the industrial control network. To mount the signal analyzer on the transmission device, the circuit needs to be designed so as to include an analyzing pin for connecting the signal analyzer. Consequently, the circuit board area in the transmission device will be reduced. Thus, a bus trace monitoring method in which a signal monitoring circuit for monitoring a high-speed serial bus signal is provided in a signal control circuit for supplying the high-speed serial bus signal to the transmission device has been developed.

To apply the bus trace monitoring method to a transmission device for cyclically transmitting a high-speed serial bus signal, the transmission device needs to have a common memory area configured to store therein data shared by transmission devices in the industrial control network and a trace memory area that has traced the common memory area. Moreover, to avoid an increase in component cost and signal lines, the common memory area and the trace memory area are provided in the same memory. However, when the common memory area and the trace memory area are provided in the same memory, the storage of data in the common memory area may sometimes conflict with the storage of data in the trace memory area. Consequently, the data transfer function by the high-speed serial bus communication may be reduced.

### BRIEF DESCRIPTION OF THE DRAWINGS

FIG. 1 is a block diagram illustrating an example of a configuration of a transmission station applied with a signal control circuit according to a first embodiment;

FIG. 2 is a diagram illustrating an example of a data configuration of parallel data output from a high-speed serial bus I/F circuit of the signal control circuit in the first embodiment;

FIG. 3 is a diagram illustrating an example of a data configuration of a common part of a header part included in the parallel data output from the high-speed serial bus I/F circuit of the signal control circuit in the first embodiment;

FIG. 4 is a flowchart illustrating an example of a flow of a storage process of trace data into a trace memory area by the signal control circuit in the first embodiment;

FIG. 5 is a block diagram illustrating an example of configuration of a transmission station applied with a signal control circuit according to a second embodiment;

FIG. 6 is a flowchart illustrating an example of a flow of a storage process of trace data into the trace memory area by the signal control circuit in the second embodiment;

FIG. 7 is a block diagram illustrating an example of a configuration of a transmission station applied with a signal control circuit according to a third embodiment; and

FIG. 8 is a flowchart illustrating an example of a flow of a storage process of trace data into the trace memory area by the signal control circuit in the third embodiment.

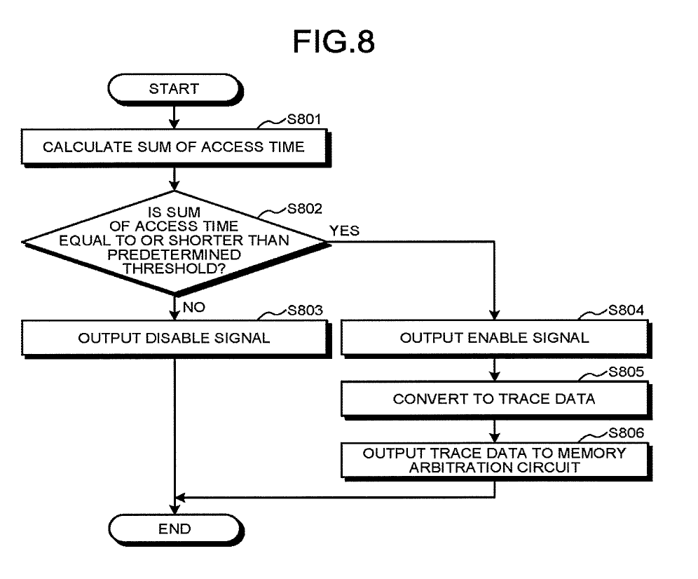

### DETAILED DESCRIPTION

In general, a signal control circuit according to an embodiment includes a high-speed serial bus I/F circuit, a data conversion circuit, a trace circuit, and a memory arbitration circuit. The high-speed serial bus I/F circuit receives serial data from an external device by high-speed serial bus communication, and converts the serial data to parallel data. The data conversion circuit converts one of the parallel data to common data to be stored in an external memory. The trace circuit converts the other parallel data to trace data to be stored in the external memory. The memory arbitration circuit stores the common data in a common memory area of the external memory, stores the trace data in a trace memory area being different from the common memory area of the external memory, and when null is supplied from outside, does not store the trace data in the trace memory area.

Hereinafter, a transmission station applied with a signal control circuit according to embodiments will be described with reference to the accompanying drawings.

### First Embodiment

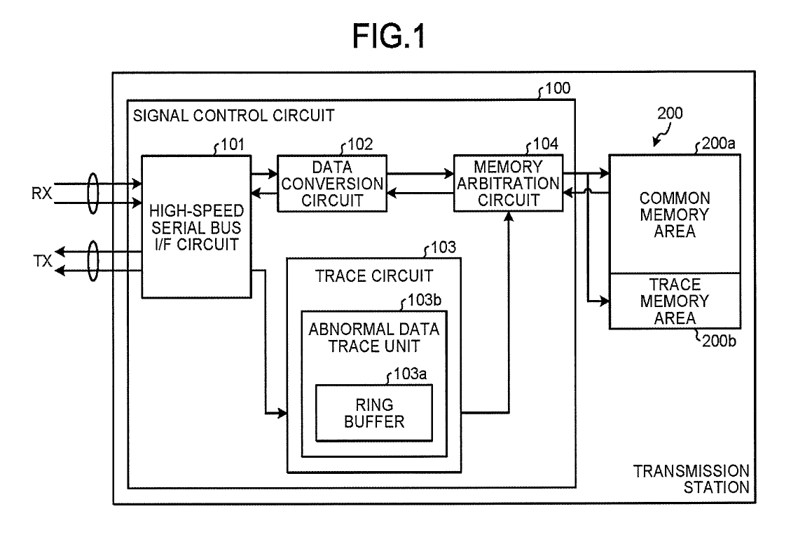

FIG. 1 is a block diagram illustrating an example of a configuration of a transmission station applied with a signal control circuit according to a first embodiment. The transmission station according to the present embodiment performs cyclic transmission with another transmission station within an industrial control network used for monitoring the status of a plant, a manufacturing facility, and the like, and automatically controlling the plant, the manufacturing facility, and the like.

In the cyclic transmission, data shared by all transmission stations in the industrial control network is received from another transmission station. The data is then written in a common memory area in the memory included in the own station. Then, the data is read out from the common memory area, and the read data is transmitted to another transmission station. In this example, the signal control circuit according to the present embodiment is applied to the transmission station that performs the cyclic transmission. However, the signal control circuit is similarly applicable to a communication device that transmits and receives various types of data with an eternal device.

As illustrated in FIG. 1, the transmission station according to the present embodiment includes a signal control circuit 100 and a memory 200. The memory 200 (an example of an external memory) includes a common memory area 200a and a trace memory area 200b. The common memory area 200a is an area capable of storing therein data transmitted and received to and from an external device, among the storage areas included in the memory 200.

The trace memory area 200b is an area different from the common memory area 200a among the storage areas included in the memory 200. Moreover, the trace memory area 200b is an area capable of storing therein data used for analyzing the contents of data transmitted and received to and from the external device, and the like.

In the present embodiment, the common memory area 200a and the trace memory area 200b are provided in the same memory 200. Consequently, it is possible to prevent an increase in cost, an increase in an area occupied by a circuit board within the transmission station, an increase in the number of pins for connecting the memories, and the like, caused by an increase in the number of memories mounted on the transmission station.

The signal control circuit 100 according to the present embodiment controls the transmission and reception of various types of data with an external device by the cyclic transmission. More specifically, the signal control circuit 100 includes a high-speed serial bus interface (I/F) circuit 101, a data conversion circuit 102, a trace circuit 103, and a memory arbitration circuit 104.

The high-speed serial bus I/F circuit 101 is a communication I/F that transmits receives serial data by high-speed serial bus communication such as Peripheral Component Interconnect (PCI) Express (registered trademark), to and from an external device. Moreover, the high-speed serial bus I/F circuit 101 converts the serial data received from the external device by the high-speed serial bus communication to parallel data. The high-speed serial bus I/F circuit 101 then outputs the parallel data to the data conversion circuit 102 and the trace circuit 103.

Moreover, the high-speed serial bus I/F circuit 101 converts data that is read out from the memory 200 by the memory arbitration circuit 104 to be supplied via the data conversion circuit 102, to serial data. The high-speed serial bus I/F circuit 101 then transmits the serial data to an external device such as another transmission station by high-speed serial bus communication.

The data conversion circuit 102 converts the parallel data supplied from the high-speed serial bus I/F circuit 101 to data (hereinafter, referred to as common data) to be stored into the memory a200. The data conversion circuit 102 then outputs the common data to the memory arbitration circuit 104. Moreover, the data conversion circuit 102 transfers the common data read out from the memory 200 by the memory arbitration circuit 104 to the high-speed serial bus I/F circuit 101.

The data conversion circuit 102 also analyzes the common data read out from the memory 200 by the memory arbitration circuit 104, and detects an abnormality in the common data. When an abnormality is detected in the common data, the data conversion circuit 102 adds a flag indicating that an abnormality is detected to the common data. In the present embodiment, when an abnormality is detected in the common data, the data conversion circuit 102 sets “1” to an error positioning of the common part included in a header part of the common data, and when an abnormality is not detected in the common data, the data conversion circuit 102 sets “0” to the error positioning.

The trace circuit 103 converts the parallel data supplied from the high-speed serial bus I/F circuit 101 to trace data to be stored in the memory 200. In the present embodiment, the trace circuit 103 includes an abnormal data trace unit 103b having a ring buffer 103a. The abnormal data trace unit 103b converts the parallel data supplied from the high-speed serial bus I/F circuit 101 to trace data, and stores the trace data in the ring buffer 103a.

When an abnormality is detected in the parallel data, the abnormal data trace unit 103b outputs the trace data stored in the ring buffer 103a to the memory arbitration circuit 104. On the other hand, when an abnormality is not detected in the parallel data, the abnormal data trace unit 103b does not output the trace data stored in the ring buffer 103a to the memory arbitration circuit 104 (in other words, outputting null to the memory arbitration circuit 104).

The memory arbitration circuit 104 stores various types of data in the memory 200, and reads out various types of data from the memory 200. More particularly, the memory arbitration circuit 104 stores the common data converted from the parallel data by the data conversion circuit 102, in the common memory area 200a.

Moreover, when an abnormality is detected in the parallel data, the memory arbitration circuit 104 stores the trace data supplied from the trace circuit 103 (in other words, trace data stored in the ring buffer 103a) in the trace memory area 200b. On the other hand, when an abnormality is not detected in the parallel data, the memory arbitration circuit 104 does not receive the trace data from the trace circuit 103 (in other words, null is supplied from the trace circuit 103 (an example of outside)). Consequently, the memory arbitration circuit 104 does not store the trace data in the trace memory area 200b.

Thus, when an abnormality is not detected in the parallel data, it is possible to prevent the storage of common data in the common memory area 200a from conflicting with the storage of trace data in the trace memory area 200b. Thus, it is possible to prevent the deterioration of the bus transfer function of the high-speed serial bus I/F circuit 101 to transmit and receive serial data, caused by the conflict between the storage of data in the trace memory area 200b and in the common memory area 200a.

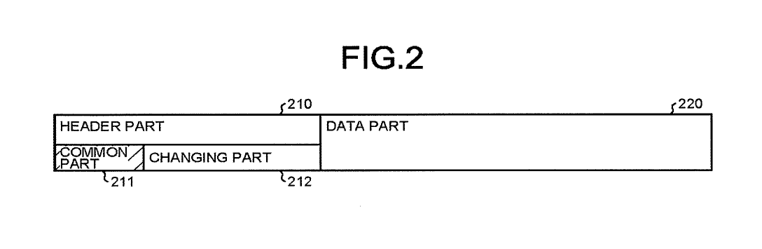

FIG. 2 is a diagram illustrating an example of a data configuration of parallel data output from a high-speed serial bus I/F circuit of the signal control circuit in the first embodiment. In the present embodiment, as illustrated in FIG. 2, the parallel data includes a header part 210 and a data part 220. The header part 210 includes a common part 1 that is not changed according to the parallel data, and a changing part 212 that is changed according to the parallel data.

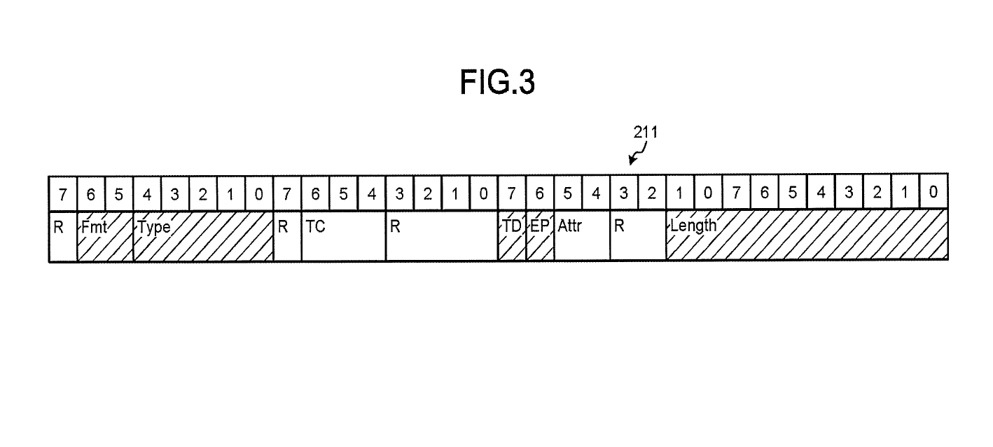

FIG. 3 is a diagram illustrating an example of a data configuration of a common part of a header part included in parallel data output from the high-speed serial bus I/F circuit of the signal control circuit in the first embodiment. As illustrated in FIG. 3, the common part 211 includes a data format (Fmt) of parallel data, a data type (Type) of the parallel data, the end-to-end cyclic redundancy check (ECRC) (TD), error positioning (EP) indicating whether an abnormality is detected in the parallel data, data length (Length) that is a length of a data payload of the parallel data, and the like.

In the present embodiment, the abnormal data trace unit 103b determines whether an abnormality is detected in the parallel data, on the basis of the error positioning included in the common part 211. In the present embodiment, the error positioning is “1” when an abnormality is detected in the parallel data, and the error positioning is “0” when the parallel data is normal.

When the parallel data is normal (in other words, when the error positioning included in the parallel data indicates “0”), the abnormal data trace unit 103b outputs null to the memory arbitration circuit 104. Consequently, when an abnormality is not detected in the parallel data, it is possible to prevent the storage of common data in the common memory area 200a from conflicting with the storage of trace data in the trace memory area 200b. Thus, it is possible to prevent the deterioration of the bus transfer function of the high-speed serial bus I/F circuit 101 to transmit and receive serial data, caused by the conflict between the storage of data in the trace memory area 200b and in the common memory area 200a.

Moreover, when the parallel data is normal, the abnormal data trace unit 103b keeps storing the trace data as much as a preset number of N pieces, in the ring buffer 103a. When the number of pieces of the trace data stored in the ring buffer 103a reaches N, the abnormal data trace unit 103b overwrites the oldest trace data with new trace data.

On the other hand, when an abnormality is detected in the parallel data (in other words, when the error positioning included in the parallel data indicates “1”), the abnormal data trace unit 103b outputs the trace data in which an abnormality is detected and the trace data in the frames before and after the trace data, among the trace data stored in the ring buffer 103a, to the memory arbitration circuit 104.

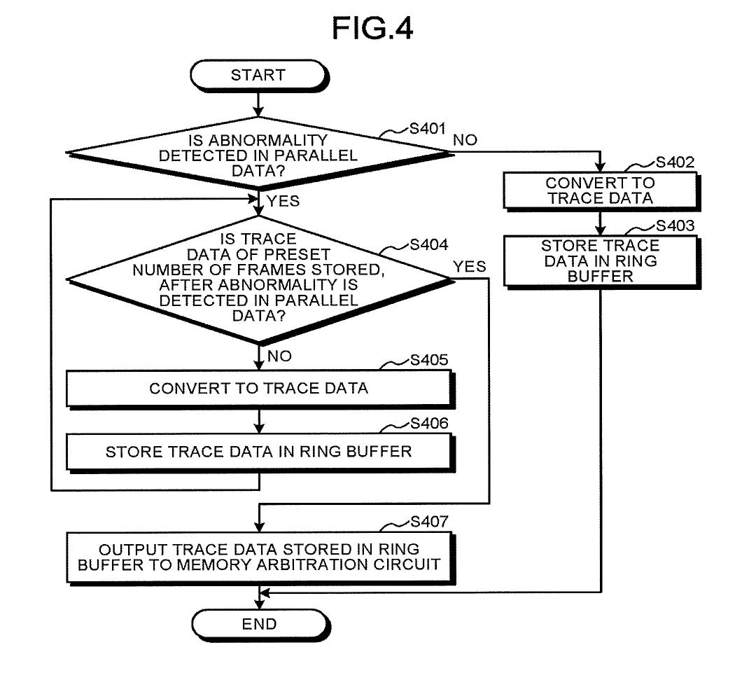

FIG. 4 is a flowchart illustrating an example of a flow of a storage process of trace data into a trace memory area by the signal control circuit in the first embodiment. When parallel data is supplied from the high-speed serial bus I/F circuit 101, the abnormal data trace unit 103b determines whether an abnormality is detected in the input parallel data (step S401).

When the input parallel data is normal (No at step S401), the abnormal data trace unit 103b converts the parallel data to trace data (step S402), and keeps storing the trace data in the ring buffer 103a (step S403). While the trace data is being stored in the ring buffer 103a, the abnormal data trace unit 103b outputs null to the memory arbitration circuit 104. Moreover, when N pieces of trace data is stored in the ring buffer 103a, the abnormal data trace unit 103b overwrites the oldest trace data with new trace data.

When an abnormality is detected in the input parallel data (Yes at step S401), the abnormal data trace unit 103b determines whether new trace data of the number of frames (N/2) set in advance is stored in the ring buffer 103a after an abnormality is detected in the parallel data (step S404). When new trace data with N/2 frames of are not stored in the ring buffer 103a after an abnormality is detected in the parallel data (No at step S404), the abnormal data trace unit 103b converts the input parallel data to trace data (step S405), and stores the trace data in the ring buffer 103a (step S406).

Then, when trace data with N/2 frames of are stored in the ring buffer 103a after an abnormality is detected in the parallel data (Yes at step S404), the abnormal data trace unit 103b outputs the trace data stored in the ring buffer 103a to the memory arbitration circuit 104 (step S407). In other words, in the present embodiment, the abnormal data trace unit 103b outputs the trace data converted from the parallel data in which an abnormality is detected, and the trace data with N/2 frames before and after the parallel data in which an abnormality is detected, to the memory arbitration circuit 104.

In this manner, with the signal control circuit 100 according to the first embodiment, when an abnormality is not detected in the parallel data, it is possible to prevent the storage of common data in the common memory area 200a from conflicting with the storage of trace data in the trace memory area 200b. Consequently, it is possible to prevent the deterioration of the bus transfer function of the high-speed serial bus I/F circuit 101 to transmit and receive serial data, caused by the conflict between the storage of data in the trace memory area 200b and in the common memory area 200a.

### Second Embodiment

A second embodiment is an example in which the trace circuit compares between the parallel data supplied from the high-speed serial bus I/F circuit and the parallel data one frame before, and detects a difference between the two pieces of parallel data; and when the deference is detected, outputs the trace data converted from the supplied input parallel data to the memory arbitration circuit. In the following explanation, explanation of the same components as those of the first embodiment is omitted.

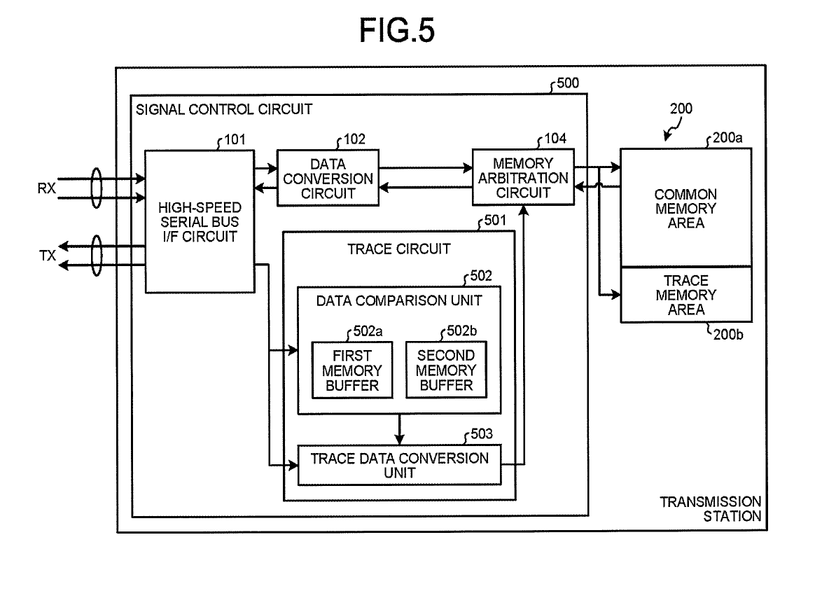

FIG. 5 is a block diagram illustrating an example of a configuration of a transmission station applied with a signal control circuit according to the second embodiment. As illustrated in FIG. 5, in the present embodiment, a trace circuit 501 included in a signal control circuit 500 has a data comparison unit 502 and a trace data conversion unit 503.

When parallel data is supplied from the high-speed serial bus I/F circuit 101, the data comparison unit 502 compares between the supplied parallel data (hereinafter, referred to as a rear frame) and the parallel data one frame before the rear frame (hereinafter, referred to as a front frame), and detects the difference between the two pieces of parallel data.

In the present embodiment, the data comparison unit 502 includes a first memory buffer 502a that stores therein the data part 220 (see FIG. 2) of the rear frame, and a second memory buffer 502b that stores therein the data part 220 (see FIG. 2) of the front frame. The data comparison unit 502 then compares between the data parts 220 (see FIG. 2) of the rear frame and the front frame, and detects the difference between the respective data parts 220.

Then, when the difference not detected between the rear frame and the front frame, the data comparison unit 502 outputs a disable signal to the trace data conversion unit 503. On the ether hand, when the difference is detected between the rear frame and the front frame, the data comparison unit 502 outputs an enable signal to the trace data conversion unit 503.

When the disable signal is supplied from the data comparison unit 502, the trace data conversion unit 503 does not output the trace data to the memory arbitration circuit 104. In other words, when the disable signal is supplied, the trace data conversion unit 503 outputs null to the memory arbitration circuit 104. Consequently, when the difference is not detected between the rear frame and the front frame, in other words, when an input from the trace circuit 501 is null, the memory arbitration circuit 104 does not store the trace data in the trace memory area 200b.

On the other hand, when an enable signal is supplied from the data comparison unit 502, the trace data conversion unit 503 converts the rear frame to the trace data, and outputs the trace data to the memory arbitration circuit 104. Consequently, the memory arbitration circuit 104 stores the trace data converted from the rear frame in the trace memory area 200b, only when there is a difference between the rear frame and the front frame. As a result, it is possible to suppress the conflict between the storage of common data in the common memory area 200a and the storage of trace data in the trace memory area 200b. Moreover, when cyclic transmission is performed between the transmission stations within an industrial control network, the data cyclically transmitted between the transmission stations infrequently varies. Consequently, when a difference is generated in the parallel data, it is possible to increase a possibility of detecting an abnormality in the parallel data on the basis of the trace data converted from the parallel data, by storing the trace data in the trace memory area 200b.

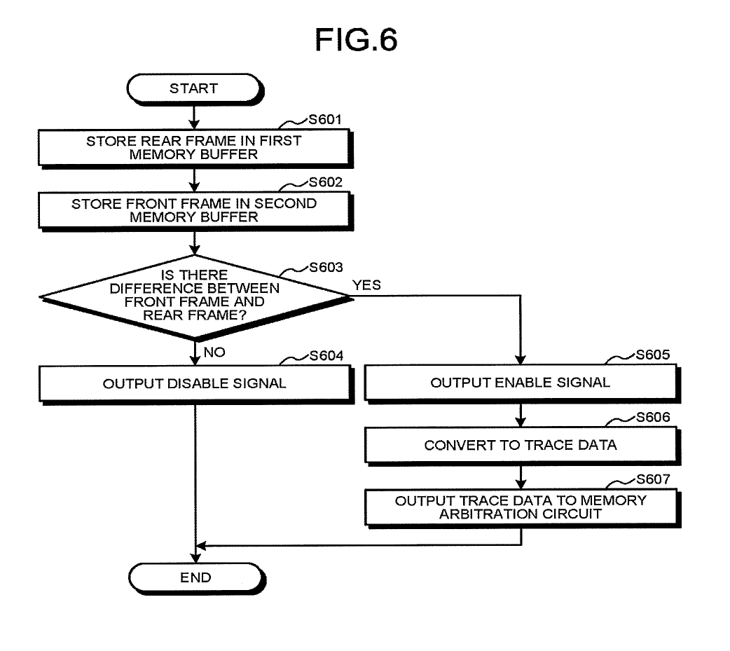

FIG. 6 is a flowchart illustrating an example of a flow of a storage process of trace data into the trace memory area by a signal control circuit in the second embodiment. When parallel data is supplied into the trace circuit 501 from the high-speed serial bus I/F circuit 101, the data comparison unit 502 stores the data part 220 of the rear frame that is the supplied input parallel data, in the first memory buffer 502a (step S601). Moreover, the data comparison unit 502 stores the data part 220 (in other words, the data part 220 of the front frame) stored in the first memory buffer 502a in the second memory buffer 502b, before the rear frame is supplied (step S602).

Next, the data comparison unit 502 compares between the data part 220 of the rear frame stored in the first memory buffer 502a and the data part 220 of the front frame stored in the second memory buffer 502b, and detects the difference between the respective data parts 220 (step S603). When the difference is not detected between the data part 220 of the rear frame and the data part 220 of the front frame (No at step S603), the data comparison unit 502 outputs a disable signal to the race data conversion unit 503 (step S604).

When the disable signal is supplied from the data comparison unit 502, the trace data conversion unit 503 does not output the race data converted from the rear frame to the memory arbitration circuit 104. In other words, the trace data conversion unit 503 outputs null to the memory arbitration circuit 104, does not store the trace data in the trace memory area 200b, and finishes the process.

On the other hand, when the difference is detected between the data part 220 of the rear frame and the data part 220 of the front frame (Yes at step S603), the data comparison unit 502 outputs an enable signal to the trace data conversion unit 503 (step S605).

When the enable signal is supplied from the data comparison unit 502, the trace data conversion unit 503 converts the rear frame to the trace data (step S606), and outputs the trace data to the memory arbitration circuit 104 (step S607).

In this manner, with the signal control circuit 500 of the second embodiment, the memory arbitration circuit 104 stores the trace data converted from the rear frame in the trace memory area 200b, only when there is a difference between the rear frame and the front frame. Consequently, it is possible to suppress the conflict between the storage of common data in the common memory area 200a and the storage of trace data in the trace memory area 200b.

### Third Embodiment

A third embodiment is an example in which the trace circuit calculates the sum of access time to a common memory area for storing common data, at each unit time, and when the sum of access time is equal to or shorter than a predetermined threshold, outputs the trace data to the memory arbitration circuit. In the following explanation, explanation of the same components as those of the first embodiment is omitted.

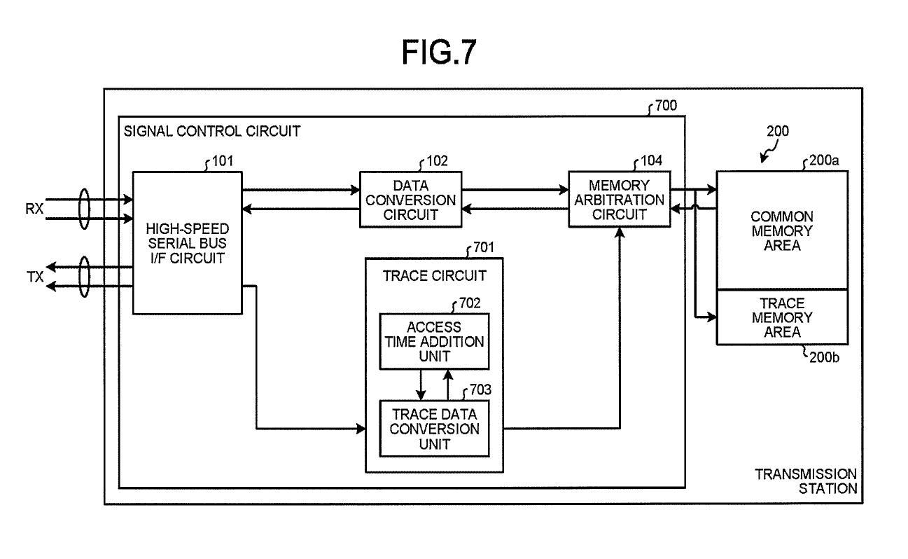

FIG. 7 is a block diagram illustrating an example of a configuration of a transmission station applied with a signal control circuit according to the third embodiment. As illustrated in FIG. 7, in the present embodiment, a trace circuit 701 included in a signal control circuit 700 has an access time addition unit 702 and a trace data conversion unit 703.

The access time addition unit 702 calculates the sum of access time to the common memory area 200a for storing common data, at each unit time. In the present embodiment, the access time addition unit 702 calculates the sum of access time at each unit time, on the basis of a common memory access request supplied from the trace data conversion unit 703, which will be described later. In this example, the common memory access request is information capable of specifying the time required for storing common data in the common memory area 200a. For example, the common memory access request is the size of common data and the like.

When the calculated sum of access time is greater than a predetermined threshold, the access time addition unit 702 outputs a disable signal to the trace data conversion unit 703. On the other hand, when the calculated sum of access time is equal to or shorter than the predetermined threshold, the access time addition unit 702 outputs an enable signal to the trace data conversion unit 703.

The trace data conversion unit 703 converts the parallel data supplied from the high-speed serial bus I/F circuit 101 to trace data. Moreover, the trace data conversion unit 703 creates a common memory access request on the basis of the trace data, and outputs the common memory access request to the access time addition unit 702.

Then, when a disable signal is supplied from the access time addition unit 702, the trace data conversion unit 703 does not output the trace data to the memory arbitration circuit 104. In other words, the trace data conversion unit 703 outputs null to the memory arbitration circuit 104, and does not store the trace data in the trace memory area 200b. On the other hand, when an enable signal is supplied from the access time addition unit 702, the trace data conversion unit 703 converts the parallel data to trace data, and outputs the trace data to the memory arbitration circuit 104.

consequently, the memory arbitration circuit 104 stores the trace data in the trace memory area 200b, only during a period when the access time to the common memory area 200a is short. As a result, it is possible to suppress the conflict between the storage of common data in the common memory area 200a and the storage of trace data in the trace memory area 200b.

FIG. 6 is a flowchart illustrating an example of a flow of a storage process of trace data into the trace memory area by the signal control circuit in the third embodiment. The access time addition unit 702 calculates the sum of access time to the common memory area 200a for storing common data, at each unit time, on the basis of a common memory access request, while the parallel data is supplied from the high-speed serial bus I/F circuit 101 to the trace circuit 701 (step S801). Then, the access time addition unit 702 determines whether the calculated sum of access time is equal to or shorter than a predetermined threshold (step S802).

When the calculated sum of access time is greater than the predetermined threshold (No at step S802), the access time addition unit 702 outputs a disable signal to the trace data conversion unit 703 (step S603).

When the disable signal is supplied from the access time addition unit 702, the trace data conversion unit 703 does not output the trace data to the memory arbitration circuit 104. In other words, the trace data conversion unit 703 outputs null to the memory arbitration circuit 104, does not store the trace data in the trace memory area 200b, and finishes the process.

On the other hand, when the calculated sum of access time is equal to or shorter than the predetermined threshold (Yes at step S802), the access time addition unit 702 outputs an enable signal to the trace data conversion unit 703 (step S804).

When an enable signal is supplied from the access time addition unit 702, the trace data conversion unit 703 converts the parallel data to trace data (step S805), and outputs the trace data to the memory arbitration circuit 104 (step S806).

In this manner, with the signal control circuit 700 of the third embodiment, the memory arbitration circuit 104 stores the trace data in the trace memory area 200b, only during a period when the access time to the common memory area 200a is short. As a result, it is possible to suppress the conflict between the storage of common data in the common memory area 200a and the storage of trace data in the trace memory area 200b.

As described above, with the first to third embodiments, it is possible to prevent the deterioration of the bus transfer function of the high-speed serial bus I/F circuit 101 to transmit and receive serial data, caused by the conflict between the storage of data in the trace memory area 200b and in the common memory area 200a.

In the embodiments described above, the trace circuits 103, 501, and 701 output the trace data to the memory arbitration circuit 104 by a first output method of the first embodiment, a second output method of the second embodiment, or a third output method of the third embodiment. However, the trace data may be output to the memory arbitration circuit 104 by using an output method selected by a user among the first output method, the second output method, and the third output method.

In this example, the first output method is a method in which, when an abnormality is detected in the parallel data, the trace circuit 103 outputs the trace data converted from the parallel data in which an abnormality is detected and the trace data before and after the trace data, among the trace data stored in the ring buffer 103a, to the memory arbitration circuit 104; and when an abnormality is not detected in the parallel data, the trace circuit 103 outputs null to the memory arbitration circuit 104.

Moreover, the second output method is a method in which the trace circuit 501 compares between the parallel data converted from serial data and the parallel data one frame before, and detects a difference between the two pieces of parallel data; and when the difference is detected, outputs the trace data to the memory arbitration circuit 104; and when the difference is not detected, outputs null to the memory arbitration circuit 104.

Furthermore, the third output method is a method in which the trace circuit 701 calculates the sum of access time to the common memory area 200a for storing common data; and when the sum of access time is equal to or shorter than a predetermined threshold, outputs the trace data to the memory arbitration circuit 104; and when the sum of access time is longer than the predetermined threshold, outputs null to the memory arbitration circuit 104.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A signal control comprising:
a high-speed serial bus I/F circuit that receives serial data from an external device by high-speed serial bus communication, and that converts the serial data to parallel data;
a data conversion circuit that converts one of the parallel data to common data to be stored in an external memory;
a trace circuit that converts another of the parallel data to trace data to be stored in the external memory; and
a memory arbitration circuit that stores the common data in a common memory area of the external memory, that stores the trace data in a trace memory area being different from the common memory area of the external memory, and when null is supplied from outside, that does not store the trace data in the trace memory area.

2. The signal control circuit according to claim 1, wherein the trace circuit includes a ring buffer configured to store therein the trace data; and when an abnormality is detected in the parallel data, outputs the trace data converted from the parallel data in which an abnormality is detected and the trace data before and after the trace data, among the trace data stored in the ring buffer, to the memory arbitration circuit; and when an abnormality is not detected in the parallel data, outputs null to the memory arbitration circuit.

3. The signal control circuit according to claim 1, wherein the trace circuit compares between the parallel data last converted from the serial data and the parallel data one frame before, and detects a difference between the two pieces of parallel data; and when the difference is detected, outputs the trace data to the memory arbitration circuit; and when the difference is not detected, outputs null to the memory arbitration circuit.

4. The signal control circuit according to claim 1, wherein the trace circuit calculates a sum of access time to the common memory area for storing the common data, at each unit time; and when the sum of access time is equal to or shorter than a predetermined threshold, outputs the trace data to the memory arbitration circuit; and when the sum of access time is longer than the predetermined threshold, outputs null to the memory arbitration circuit.

5. The signal control circuit according to claim 1, wherein the trace circuit outputs the trace data to the memory arbitration circuit according to an output method selected by a user, among
a first output method in which the trace circuit includes a ring buffer configured to store therein the trace data; and when an abnormality is detected in the parallel data, that outputs the trace data converted from the parallel data in which an abnormality is detected and the trace data before and after the trace data, among the trace data stored in the ring buffer, to the memory arbitration circuit; and when an abnormality is not detected in the parallel data, that outputs null to the memory arbitration circuit;
a second output method that compares between the parallel data last converted from the serial data and the parallel data one frame before, and that detects a difference between the two pieces of parallel data; and when the difference is detected, that outputs the trace data to the memory arbitration circuit; and when the difference is not detected, that outputs null to the memory arbitration circuit; and
a third output method that calculates a sum of access time to the common memory area for storing the common data, at each unit time; and when the sum of access time is equal to or shorter than a predetermined threshold, outputs the trace data to the memory arbitration circuit; and when the sum of access time is longer than the predetermined time, outputs null to the memory arbitration circuit.
